(19) United States
(12) Patent Application Publication
(10) Pub. No.: US 2008/0156416 A1
(43) Pub. Date: Jul. 3, 2008

(54) Methods of forming piezoelectric resonant device having piezoelectric resonator

(76) Inventors: Jae-Hyung Choi, Yongin-si (KR); Ki-Hyun Kim, Yongin-si (KR); Ju-Ho Kim, Ansan-si (KR); Su-Min Ko, Seoul (KR)

Correspondence Address: Howard IP Law Group, P.O. Box 226, Fort Washington, PA, 19034, US

(21) Appl. No.: 11/655,479

(22) Filed: Jan. 19, 2007

(30) Foreign Application Priority Data
Dec. 29, 2006 (KR) 10-2006-0137471

(51) Int. Cl. B44C 1/22

(52) U.S. Cl. 156/153

(57) ABSTRACT

A method of forming a piezoelectric resonant device having a piezoelectric resonator is provided. The method offers a plan for increasing the electrical characteristics of the piezoelectric resonator by ensuring a green substrate having a desired thickness from a green body. According to the method, two green bodies are prepared. Green substrates are formed by sequentially performing sintering and grinding processes on the green bodies. Internal and external substrate electrode patterns are formed on facing surfaces between the green substrates and opposite surfaces to the facing surfaces. An adhesive agent is formed on the facing surfaces between the green substrates. A piezoelectric resonant pattern is formed by cutting the green substrates. A piezoelectric resonator is formed by disposing respective connection electrodes on both sides of the piezoelectric resonant pattern.

### CROSS-REFERENCE TO RELATED APPLICATION

This application claims the benefit of Korean Patent Application No. 10-2006-0137471, filed Dec. 29, 2006, the disclosure of which is hereby incorporated herein by reference in its entirety.

### BACKGROUND OF THE INVENTION

1. Field of the Invention

The present invention relates to methods of forming a piezoelectric resonant device, and more particularly, to methods of forming a piezoelectric resonant device having a piezoelectric resonator.

2. Description of the Related Art

In general, piezoelectric resonant devices are electronic discrete devices which are able to obtain acoustic waves with a target frequency from electromagnetic waves with several frequencies using a piezoelectric resonator. Here, the piezoelectric resonator may be formed through pre- and post-processing steps. The pre-processing step includes forming inner substrate electrode patterns on surfaces facing each other between green bodies, and forming green substrates by performing sintering and grinding processes on the green bodies. The green bodies may be formed of a piezoelectric material. And, the post-processing step includes forming external substrate electrode patterns on surfaces facing each other between the green substrates, and cutting the green substrates. A thickness of each green substrate can provide acoustic waves with a target frequency to the piezoelectric resonator.

However, the piezoelectric resonator may not show the acoustic waves with a target frequency to a piezoelectric resonant device because the piezoelectric resonator is formed through the processing steps of sintering and grinding the green bodies. That is, the green bodies have internal substrate electrode patterns between them before the sintering process. Also, the green bodies are sintered to have a different thermal expansion coefficient from the inner substrate electrode patterns during the sintering process. Thus, after the sintering process, the green bodies may have different thicknesses at parts in contact with the inner substrate electrode patterns and near the inner substrate electrode patterns. Also, each green body may have a different thickness at an upper part and a lower part between which the inner substrate electrode pattern is interposed due to an effect of gravity according to a physical phenomenon by the grinding process.

A method of forming the piezoelectric resonator is disclosed by Takeshima Tetsuo in Korean Patent No. 10-0307679. According to Korean Patent No. 10-0307679, several green sheets (green bodies) are prepared and conductive pastes are formed on the respective green sheets. A multilayered base is formed by stacking and plasticizing the green sheets. Here, the conductive pastes are formed of inner electrodes after the plasticizing process, respectively. Polarized electrodes are formed on selected both sides of the multilayered base, respectively. The multilayered base is polarized by the polarized electrodes, a multilayered body is formed by cutting the multilayered base, insulating layers and external electrodes are formed on the multilayered body, and the external electrodes, the insulating layers and the multilayered body are cut to form a piezoelectric resonator.

However, this method of forming the piezoelectric resonator includes interposing conductive pastes between green sheets and forming inner electrodes by a plasticizing process. Here, the green sheets may have different thicknesses at a part in contact with the conductive pastes and near the conductive pastes through the plasticizing process. Also, this method of forming the piezoelectric resonator may raise production cost due to complicated formation steps.

### SUMMARY OF THE INVENTION

An embodiment of the invention provides methods of forming a piezoelectric resonant device capable of minimizing an effect of a production process on green bodies in order to improve an electrical characteristic of a piezoelectric resonator.

In one aspect, the invention is directed to methods of forming a piezoelectric resonant device having a piezoelectric resonator.

In a first embodiment, the method comprises preparing two green bodies, each green body being sintered and formed into a cube surrounded by six planes. Green substrates are formed by grinding each green body, respectively. Substrate polarizing layers are formed on facing surfaces between the green substrates, and on opposite surfaces to the facing surfaces, respectively. The green substrates are polarized using the substrate polarizing layers. Also, internal and external substrate electrode patterns are formed on the green substrates using the substrate polarizing layers. The internal and external substrate electrode patterns are formed on the facing surfaces between the green substrates, and the opposite surfaces to the facing surfaces, respectively, and an adhesive agent is formed on the facing surfaces between the green substrates. At least one piezoelectric resonant pattern is formed by cutting the green substrates, and the piezoelectric resonant pattern has a connecting adhesive pattern, an insulating adhesive pattern, resonant patterns, and external and internal resonant electrode patterns. The external and internal resonant electrode patterns and the resonant patterns correspond to the external and internal substrate electrode patterns and the green substrates, respectively. The connecting and insulating adhesive patterns correspond to the adhesive agent. A piezoelectric resonator having connection electrodes between the internal resonant electrode patterns and between the external resonant electrode patterns to be disposed on the piezoelectric resonant pattern is formed.

In a second embodiment, the method comprises preparing two or more even number of green bodies. Each green body is sintered and formed into a cube surrounded by six planes. Green substrates are formed by grinding the green bodies, and substrate polarizing layers are formed on facing surfaces between the green substrates and opposite surfaces to the facing surfaces. The green substrates are polarized using the substrate polarizing layers. Two substrates are selected from the green substrates to thereby form internal and external substrate electrode patterns thereon. The internal and external substrate electrode patterns are formed on the facing surfaces between the green substrates and the opposite surfaces to the facing surfaces using the substrate polarizing layer, respectively. An adhesive agent is formed on the facing surfaces between the two green substrates, and at least one piezoelectric resonant pattern is formed by cutting the two green substrates. The piezoelectric resonant pattern has a connecting adhesive pattern, an insulating adhesive pattern, resonant patterns, external resonant electrode patterns, and internal resonant electrode patterns. The external and internal resonant electrode patterns and the resonant patterns correspond to the external and internal substrate electrode patterns and the green substrates, respectively. The connecting and insulating adhesive patterns correspond to the adhesive agent. A piezoelectric resonator having connection electrodes between the internal resonant electrode patterns and between the external resonant electrode patterns to be disposed on the piezoelectric resonant pattern is formed. Two from the rest of the green substrates are repeatedly selected in a unit to sequentially form the internal and external substrate electrode patterns thereon, the adhesive agent, the piezoelectric resonant pattern, and the piezoelectric resonator.

In a third embodiment, two or more even number of green bodies are prepared. Each green body is sintered and formed into a cube surrounded by six planes. Green substrates are formed by grinding the green bodies, respectively, and substrate polarizing layers are formed on facing surfaces between the green substrates and opposite surfaces to the facing surfaces. The green substrates are polarized using the substrate polarizing layers, and two green substrates are selected from the green substrates to form internal and external substrate electrode patterns thereon. The internal and external substrate electrode patterns are formed on the facing surfaces between the two green substrates and the opposite surfaces to the facing surfaces using the substrate polarizing layers. An adhesive agent is formed on the facing surfaces between the two green substrates. Two from the rest of the green substrates are repeatedly selected in a unit to sequentially form the internal and external substrate electrode patterns thereon, and the adhesive agent. Piezoelectric resonant patterns are formed by cutting the green substrates, each of the piezoelectric resonant patterns having a connecting adhesive pattern, an insulating adhesive pattern, resonant patterns, external resonant electrode patterns, and internal resonant electrode patterns. The external and internal resonant electrode patterns and the resonant patterns correspond to the external and internal substrate electrode patterns and the green substrates, respectively. The connecting and insulating adhesive patterns correspond to the adhesive agent. One from the piezoelectric resonant patterns is repeatedly selected in a unit, thereby forming a plurality of piezoelectric resonators having connection electrodes between the internal resonant electrode patterns and also between the external resonant electrode patterns to be disposed on the piezoelectric resonant pattern.

In a fourth embodiment, two green bodies are prepared. Each green body is sintered and formed into a cube surrounded by six planes. Green substrates are formed by grinding the green bodies, respectively. Internal and external substrate electrode patterns are formed on facing surfaces between the green substrates, and on opposite surfaces to the facing surfaces, respectively. The green substrates are polarized using the internal and external substrate electrode patterns, and an adhesive agent is formed on the facing surfaces between the green substrates. At least one piezoelectric resonant pattern is formed by cutting the green substrates, the least one piezoelectric resonant pattern having a connecting adhesive pattern, an insulating adhesive pattern, resonant patterns, external resonant electrode patterns, and internal resonant electrode patterns. The external and internal resonant electrode patterns and the resonant patterns correspond to the external and internal substrate electrode patterns and the green substrates, respectively. The connecting and insulating adhesive patterns correspond to the adhesive agent. A piezoelectric resonator having connection electrodes between the internal resonant electrode patterns and between the external resonant electrode patterns to be disposed on the piezoelectric resonant pattern, is formed.

### BRIEF DESCRIPTION OF THE DRAWINGS

The foregoing and other objects, features and advantages of the invention will become more apparent from the following more particular description of exemplary embodiments of the invention and the accompanying drawings. The drawings are not necessarily to scale, emphasis instead being placed upon illustrating the principles of the invention.

FIGS. 1 to 7 are perspective views illustrating a method of forming a piezoelectric resonant device having a piezoelectric resonator according to the present invention.

FIGS. 8 is a cross-sectional view of a multilayered piezoelectric resonant device having the piezoelectric resonator of FIG. 7.

FIG. 9 is a cross-sectional view of a cap-shaped piezoelectric resonant device having the piezoelectric resonator of FIG. 7.

### DETAILED DESCRIPTION OF THE INVENTION

The present invention will now be described more fully hereinafter with reference to the accompanying drawings, in which exemplary embodiments of the invention are shown.

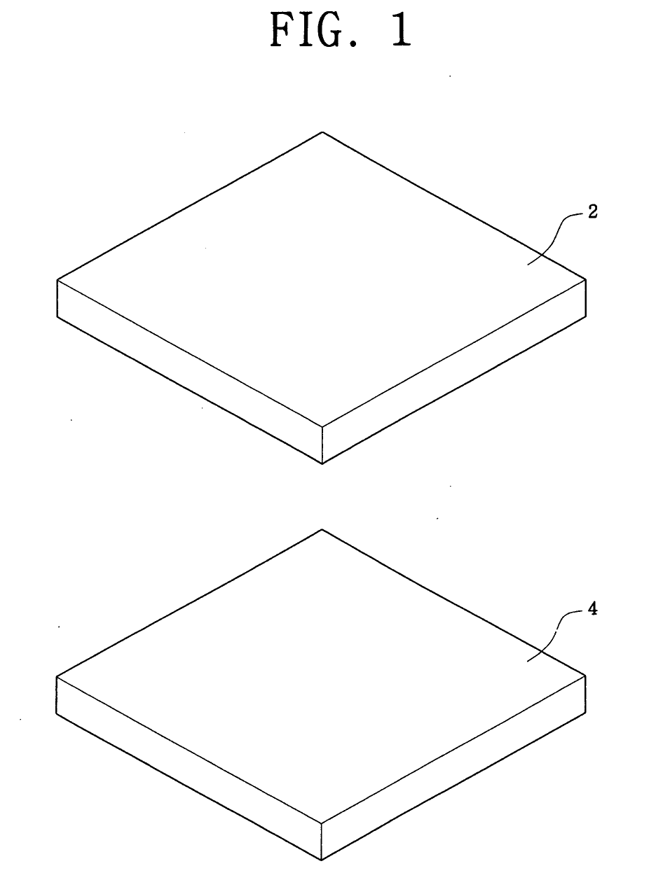

FIGS. 1 to 7 are perspective views illustrating a method of forming a piezoelectric resonant device having a piezoelectric resonator according to the present invention.

Referring to FIG. 1, two green bodies 2 and 4 are prepared. The green bodies may be ensured by a green compact (not illustrated). That is, the green bodies 2 and 4 may be formed by pressing, casting or extruding the green compact, techniques which are well known to those skilled in the art. Each of the green bodies 2 and 4 may be formed to be surrounded by six planes. Alternatively, the green bodies 2 and 4 may be prepared in two or more even number and the green compact may be formed of a piezoelectric material. Here, the green compact may be formed of several crystals.

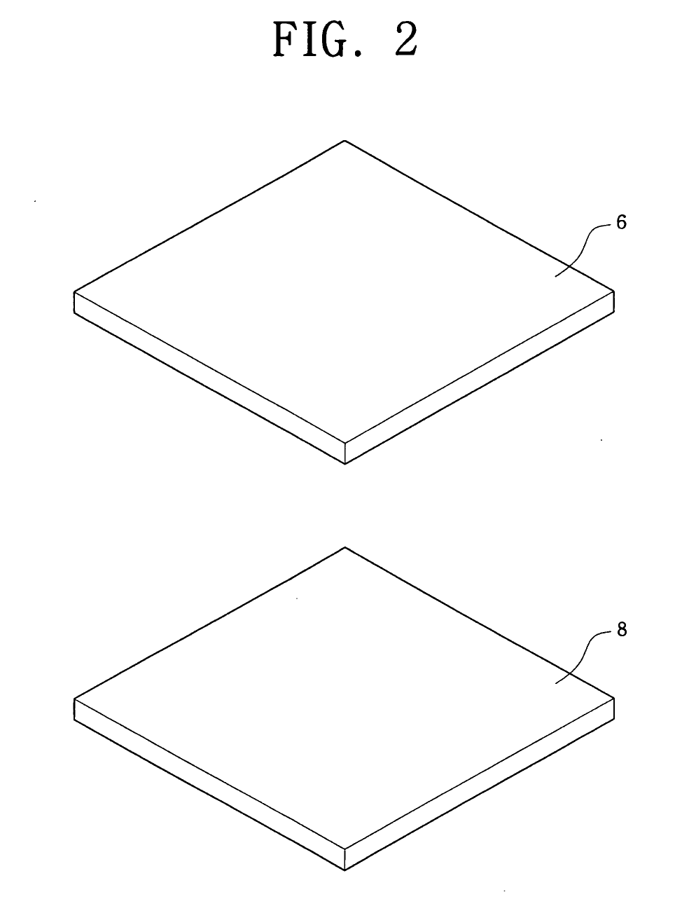

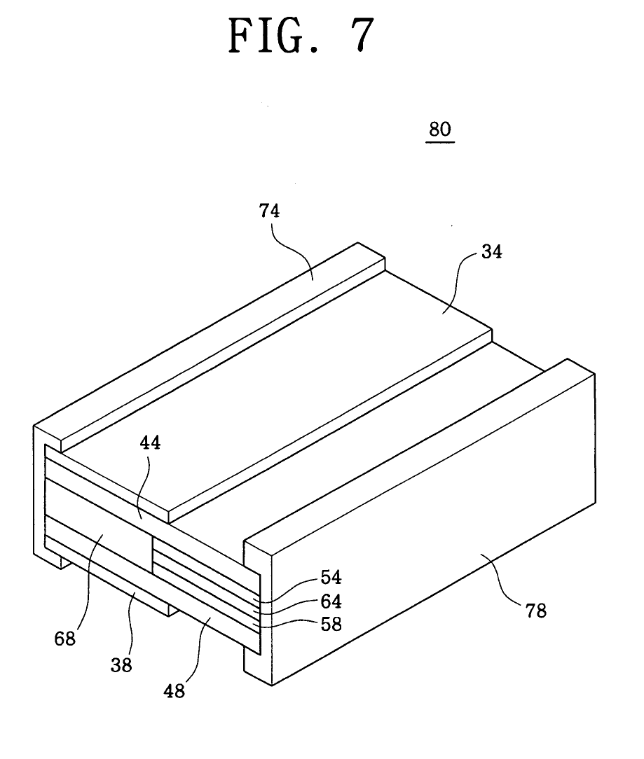

Referring to FIGS. 1 and 2, a sintering process using a predetermined temperature is performed to harden the green bodies 2 and 4. The predetermined temperature in the sintering process may have an appropriate value in a range of temperatures well known to those in the art to harden the green bodies 2 and 4, or to improve an electrical characteristic of a piezoelectric resonator 70 of FIG. 7. Subsequently, after the sintering process, a grinding process is performed on the green bodies 2 and 4, thereby forming green substrates 6 and 8 as illustrated in FIG. 2.

Meanwhile, when two green bodies 2 and 4 are prepared, forming the green substrates 6 and 8 may comprise: two-dimensionally arranging the green bodies 2 and 4 in a grinding apparatus according to first and fourth embodiments of the present invention; and simultaneously performing the grinding process onto the green substrates 2 and 4. Alternatively, forming the green substrates 6 and 8 may comprise: inserting one of the green bodies 2 and 4 into the grinding apparatus according to the first and fourth embodiments of the present invention; performing the grinding process on the selected one; and inserting the other green body into the grinding apparatus to grind. As a result, the green substrates 2 and 4 may be formed to have the same thickness through the grinding process.

When two or more even number of green bodies are prepared, according to second and third embodiments of the present invention, forming green substrates comprises: two-dimensionally arranging the green bodies in the grinding apparatus; and simultaneously performing the grinding process to the green bodies. Alternatively, forming the green substrates may comprise: inserting one of the green bodies into the grinding apparatus; performing the grinding process on the selected one; and subsequently repeatedly selecting one from the rest of the green bodies, inserting the selected one into the grinding apparatus, and performing the grinding process. As a result, the green substrates may be formed to the same thickness through the grinding process.

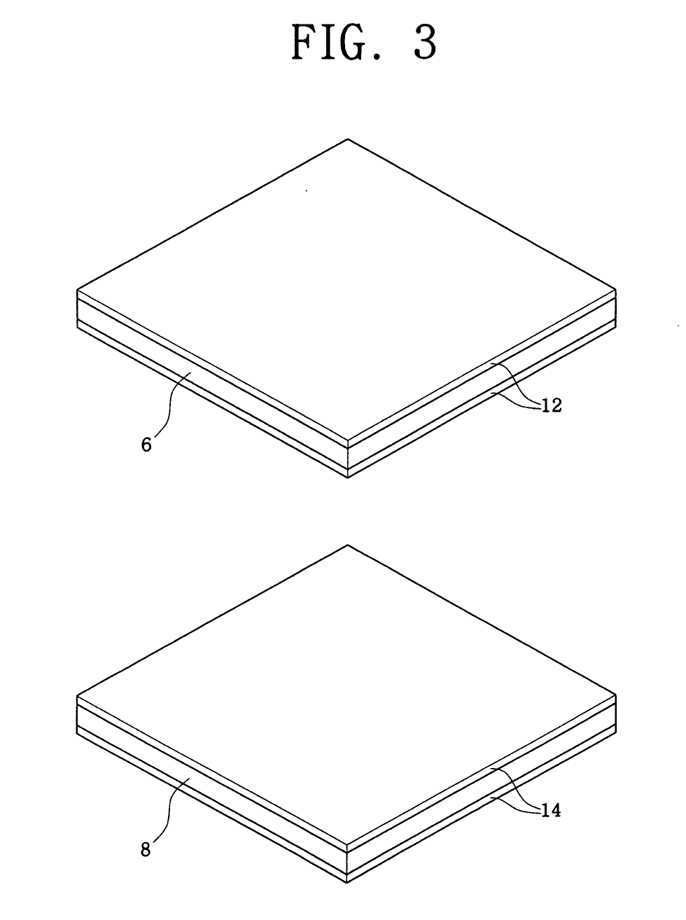

Referring to FIGS. 2 and 3, substrate polarizing layers 12 and 14 are formed on the green substrates 6 and 8 as illustrated in FIG. 3. The substrate polarizing layers 12 and 14 may be formed of a conductive material including silver (Ag), and each substrate polarizing layer 12 or 14 may be formed of at least one conductive layer. When two green bodies 12 and 14 are prepared, the green substrates 6 and 8 are polarized by the substrate polarizing layers 12 and 14 according to the first embodiment of the present invention. Here, polarizing the green substrates 6 and 8 comprises directly contacting electrical wires to the substrate polarizing layers 12 and 14 and aligning polarized axes of the crystals in the green substrates 6 and 8 in the same direction. Alternatively, polarizing the green substrates 6 and 8 may comprise forming an electric field around the substrate polarizing layers 12 and 14, and aligning the polarized axes of the crystals in the green substrates 6 and 8 parallel to each other.

Meanwhile, when two or more even number of green bodies are prepared, the green substrates are polarized using the substrate polarizing layers according to the second and third embodiments of the present invention. Here, polarizing the green substrates comprises directly contacting electrical wires to the substrate polarizing layers to align the polarized exes of the crystals in the green substrates parallel to each other. Alternatively, polarizing the green substrates may comprise forming an electric field around the substrate polarizing layers to align the polarized axes of the crystals in the green substrates parallel to each other. Accordingly, the substrate polarizing layers of the second and third embodiments of the present invention may be formed of the same material as the substrate polarizing layers 12 and 14 of the first embodiment of the present invention. The substrate polarizing layers of the second and third embodiments of the present invention may be formed of at least one conductive layer. Unlike the first and third embodiments of the present invention, the fourth embodiment does not have the substrate polarizing layers 12 and 14 on the green substrates 6 and 8.

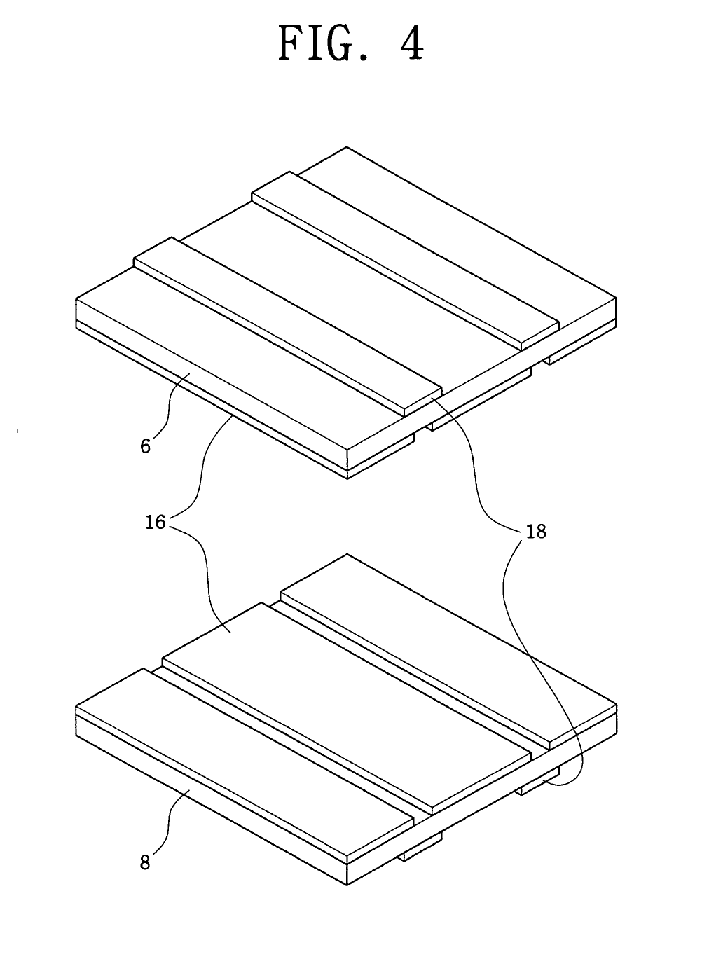

Referring to FIGS. 3 and 4, internal and external substrate electrode patterns 16 and 18 are formed on the green substrates 6 and 8 according to the first embodiment of the present invention as illustrated in FIG. 4. The internal and external substrate electrode patterns 16 and 18 may be formed on the facing surfaces between the green substrates 6 and 8, and the opposite surfaces to the facing surfaces, respectively. Here, when two green bodies 2 and 4 are prepared, forming the internal and external substrate electrode patterns 16 and 18 comprises: forming photoresist patterns on the substrate polarizing layers 12 and 14; removing the substrate polarizing layers 12 and 14 using the photoresist patterns and the green substrates 6 and 8 as an etch mask and an etch buffer layer, respectively; and removing the photoresist patterns from the green substrates 6 and 8. Here, the photoresist patterns may be formed to correspond to the internal substrate electrode patterns 16, respectively.

Subsequently, forming the internal and external substrate electrode patterns 16 and 18 further comprises: forming other photoresist patterns on the substrate polarizing layers 12 and 14; removing the substrate polarizing layers 12 and 14 using the other photoresist layers and the green substrates 6 and 8 as an etch mask and an etch buffer layer; and removing the other photoresist patterns from the green substrates 6 and 8. Here, the other photoresist patterns may be formed to correspond to the external substrate electrode patterns 18, respectively. As a result, the internal substrate electrode patterns 16 may be disposed between the external substrate electrode patterns 18 to overlap each other. Alternatively, the external substrate electrode patterns 18 may be formed to be disposed between the internal substrate electrode patterns 16.

Referring again to FIGS. 3 and 4, when two or more even number of green bodies are prepared, two substrates are selected from the green substrates, and the internal and external substrate electrode patterns 16 and 18 are formed thereon in the same way as the first embodiment of the present invention according to the second and third embodiments of the present invention. Thus, the internal and external substrate electrode patterns 16 and 18 may be formed on the facing surfaces between the two green substrates 6 and 8 and the opposite surfaces to the facing surfaces using the substrate polarizing layers 12 and 14, respectively.

Meanwhile, forming the internal and external substrate electrode patterns 16 and 18 comprises: forming photoresist patterns on the substrate polarizing layers 12 and 14; removing the substrate polarizing layers 12 and 14 using the photoresist patterns and the two green substrates 6 and 8 as an etch mask and an etch buffer layer, respectively; and removing the photoresist patterns from the two green substrates 6 and 8. Here, the photoresist patterns may be formed to correspond to the internal substrate electrode patterns 16, respectively.

Subsequently, forming the internal and external substrate electrode patterns 16 and 18 further comprises: forming other photoresist patterns on the substrate polarizing layers 12 and 14; removing the substrate polarizing layers 12 and 14 using the other photoresist patterns and the two green substrate 6 and 8 as an etch mask and an etch buffer layer; and removing the other photoresist patterns from the two green substrates 6 and 8. Here, the other photoresist patterns may be formed to correspond to the external substrate electrode patterns 18, respectively. Therefore, the internal substrate electrode patterns 16 may be disposed between the external substrate electrode patterns 18 to overlap each other. Alternatively, the external substrate electrode patterns 18 may be formed to be disposed between the internal substrate electrode patterns 16.

Referring again to FIGS. 3 and 4, unlike the first to third embodiment of the present invention, when two green bodies 2 and 4 are prepared, the internal and external substrate electrode patterns 16 and 18 are formed on the facing surfaces between the green substrates 6 and 8 and the opposite surfaces to the facing surfaces, respectively, according to the fourth embodiment of the present invention. Here, forming the internal and external substrate electrode patterns 16 and 18 comprises forming conductive paste patterns on the green substrates 6 and 8, and forming other conductive paste patterns on the green substrates 6 and 8. Also, forming the internal and external substrate electrode patterns 16 and 18 further comprises thermally treating the green substrates 6 and 8, the conductive paste patterns and the other conductive paste patterns. The conductive pastes and the other conductive pastes may be formed of a conductive material, including Ag.

Meanwhile, the conductive paste patterns may be formed to correspond to the internal substrate electrode patterns 16, respectively. The other conductive paste patterns may be formed to correspond to the external substrate electrode patterns 18, respectively. Also, the internal substrate electrode patterns 16 may be disposed between the external substrate electrode patterns 18 to overlap each other. Alternatively, the external substrate electrode patterns 18 may be formed to be disposed between the internal substrate electrode patterns 16. Subsequently, the green substrates 6 and 8 are polarized using the internal and external substrate electrode patterns 16 and 18 according to the fourth embodiment of the present invention. Here, polarizing the green substrates 6 and 8 comprises directly contacting electrical wires to the internal and external substrate electrode patterns 16 and 18 to align polarized axes of crystals parallel to each other in the green substrates 6 and 8. Alternatively, polarizing the green substrates 6 and 8 may comprise forming an electric field around the internal and external substrate electrode patterns 16 and 18 to align the polarized axes of the crystals parallel to each other in the green substrates 6 and 8.

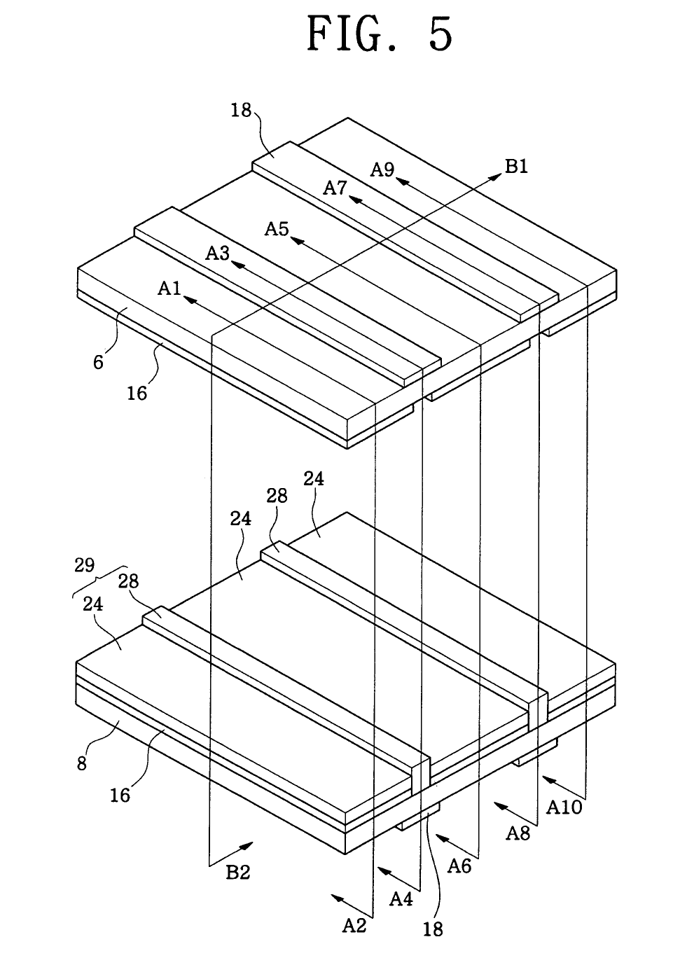

Referring to FIGS. 4 and 5, when two green bodies 2 and 4 are prepared, an adhesive agent 29 is formed on the facing surfaces between the green substrates 6 and 8 according to the first and fourth embodiments of the present invention as illustrated in FIG. 5. The adhesive agent 29 is formed of a connecting adhesive layer 24 and an insulating adhesive layer 28. The insulating adhesive layer 28 may be formed of an insulating material and the connecting adhesive layer 24 may be formed of a conductive material. Here, the connecting adhesive layer 24 may be formed to be in contact with the internal substrate electrode patterns 16, and the insulating adhesive layer 28 may be disposed between the internal substrate electrode patterns 16 to be in contact with the green substrates 6 and 8.

Alternatively, when two or more even number of green bodies are prepared, a pair of substrates from the green substrates are selected, and the adhesive agent 29 is formed on the facing surfaces between the two green substrates 6 and 8 according to the second and third embodiments of the present invention. The adhesive agent 29 is formed of the connecting adhesive layer 24 and the insulating adhesive layer 28. Here, the connecting adhesive layer 24 may be in contact with the internal substrate electrode patterns 16, and the insulating adhesive layer 28 may be disposed between the internal substrate electrode patterns 16 to be in contact with the green substrates 6 and 8.

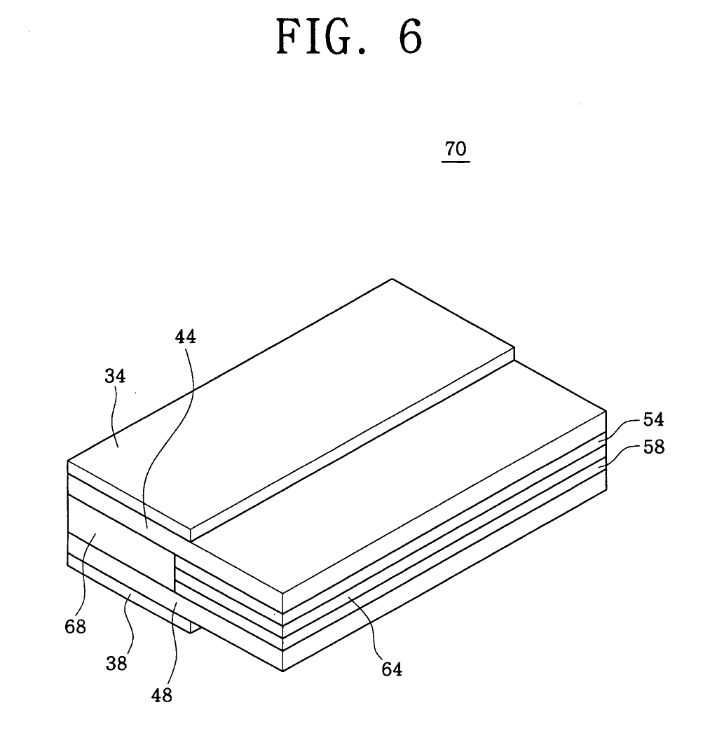

Referring to FIGS. 5 and 6, when two green bodies 2 and 4 are prepared, at least one piezoelectric resonant pattern 70 is formed by cutting the green substrates 6 and 8 according to the first and fourth embodiments of the present invention as illustrated in FIG. 6. Cutting the green substrates 6 and 8 may be performed by a dicing saw technique. The piezoelectric resonant pattern 70 has external resonant electrode patterns 34 and 38, resonant patterns 44 and 48, internal resonant electrode patterns 54 and 58, connecting adhesive pattern 64 and the insulating adhesive pattern 68. The insulating adhesive pattern 68 may be disposed between the resonant patterns 44 and 48 to be in contact with the connecting adhesive pattern 64 and the external and internal resonant electrode patterns 34, 38, 54 and 58. The insulating adhesive pattern 68 corresponds to the insulating adhesive layer 28. The connecting adhesive pattern 64 may be formed to be disposed between the internal resonant electrode patterns 54 and 58. The connecting adhesive pattern 64 corresponds to the connecting adhesive layer 24.

The internal resonant electrode patterns 54 and 58 may be formed to be disposed on one side of the facing surfaces between the resonant patterns 44 and 48 to face each other. The external resonant electrode patterns 34 and 38 may be formed on the opposite surfaces to the facing surfaces between the resonant patterns 44 and 48 to overlap the other side of the facing surfaces between the resonant patterns 44 and 48. The external resonant electrode patterns 34 and 38 may or may not overlap the internal resonant electrode patterns 54 and 58. The external and internal resonant electrode patterns 34, 38, 54 and 58 correspond to the internal and external substrate electrode patterns 16 and 18, respectively.

Forming the piezoelectric resonant pattern 70 comprises cutting the green substrates 6 and 8 along line B1-B2 as sequentially passing between the internal and external substrate electrode patterns 16 and 18 along lines A1-A2, A3-A4, A5-A6, A7-A8 and A9-A10, and crossing the internal and external substrate electrode patterns 16 and 18 as illustrated in FIG. 5. Alternatively, forming the piezoelectric resonant pattern 70 may comprise sequentially cutting the green substrates 6 and 8 along line B1-B2 crossing the internal and external substrate electrode patterns 16 and 18, and along lines A1-A2, A3-A4, A5-A6, A7-A8 and A9-A10 passing between the internal and external substrate electrode patterns 16 and 18.

Referring again to FIGS. 5 and 6, when two or more even number of green bodies are prepared, at least one piezoelectric resonant pattern 70 is formed by cutting two green substrates 6 and 8, which are selected from the green substrates according to the second embodiment of the present invention. Cutting the two green substrates 6 and 8 may be performed by the dicing saw technique. The piezoelectric resonant pattern 70 has external resonant electrode patterns 34 and 38, resonant patterns 44 and 48, internal resonant electrode patterns 54 and 58, a connecting adhesive pattern 64 and an insulating adhesive pattern 68. The insulating adhesive pattern 68 (corresponding to the insulating adhesive layer 28) may be disposed between the resonant patterns 44 and 48 to be in contact with the connecting adhesive pattern 64, and the external and internal resonant electrode patterns 34, 38, 54 and 58. The connecting adhesive pattern 64 corresponding to the connecting adhesive layer 24 may be formed to be disposed between the internal resonant electrode patterns 54 and 58.

The internal resonant electrode patterns 54 and 58 may be disposed on one side respectively of the facing surfaces between the resonant patterns 44 and 48 to face each other. The external resonant electrode patterns 34 and 38 may be formed on the opposite surfaces to the facing surfaces between the resonant patterns 44 and 48 to overlap the other side of the facing surfaces between the resonant patterns 44 and 48. The external resonant electrode patterns 34 and 38 may or may not overlap the internal resonant electrode patterns 54 and 58. The external and internal resonant electrode patterns 34, 38, 54 and 58 correspond to the internal and external substrate electrode patterns 16 and 18, respectively.

Forming the piezoelectric resonant pattern 70 comprises sequentially cutting the green substrates 6 and 8, as illustrated in FIG. 5, along lines A1-A2, A3-A4, A5-A6, A7-A8, and A9-A10 passing between the internal and external substrate electrode patterns 16 and 18, and along line B1-B2 crossing the internal and external substrate electrode patterns 16 and 18. Alternatively, forming the piezoelectric resonant pattern 70 may comprise sequentially cutting the green substrates 6 and 8 along line B1-B2 crossing the internal and external substrate electrode patterns 16 and 18, and along lines A1-A2, A3-A4, A5-A6, A7-A8 and A9-A10 passing between the internal and external substrate electrode patterns 16 and 18.

Referring again to FIGS. 5 and 6, when two or more even number of green bodies are prepared, according to the third embodiment of the present invention, a pair of substrates are selected from the rest of the green substrates so as to form the internal and external substrate electrode patterns, and the adhesive agent is formed, sequentially. Thus, the third embodiment of the present invention may provide several pairs of green substrates. Subsequently, piezoelectric resonant patterns are formed by cutting the green substrates. Cutting the green substrates may be performed by the dicing saw technique.

Each piezoelectric resonant pattern has the same structure as the piezoelectric resonant pattern 70 of FIG. 6. Thus, each piezoelectric resonant pattern has external resonant electrode patterns 34 and 38, resonant patterns 44 and 48, internal resonant electrode patterns 54 and 58, a connecting adhesive pattern 64 and an insulating adhesive pattern 68. The insulating adhesive pattern 68 (corresponding to the insulating adhesive layer 28) may be disposed between the resonant patterns 44 and 48 to be in contact with the connecting adhesive pattern 64, and external and internal resonant electrode patterns 34, 38, 54 and 58. The connecting adhesive pattern 64 (corresponding to the connecting adhesive layer 24) may be disposed between the internal resonant electrode patterns 54 and 58.

The internal resonant electrode patterns 54 and 58 may be disposed on one side of the respective facing surfaces between the resonant patterns 44 and 48 to face each other as illustrated in FIG. 6. The external resonant electrode patterns 34 and 38 may be formed on opposite surfaces to the facing surfaces between the resonant patterns 44 and 48 to overlap the other side of the facing surfaces of the resonant patterns 44 and 48. The external resonant electrode patterns 34 and 38 may or may not overlap the internal resonant electrode patterns 54 and 58. The external and internal resonant electrode patterns 34, 38, 54 and 58 correspond to the internal and external substrate electrode patterns 16 and 18, respectively.

Forming the piezoelectric resonant patterns comprises sequentially cutting the green substrates along lines A1-A2, A3-A4, A5-A6, A7-A8 and A9-A10 passing between the internal and external substrate electrode patterns 16 and 18, and along line B1-B2 crossing the internal and external substrate electrode patterns 16 and 18 as illustrated in FIG. 6. Alternatively, forming the piezoelectric resonant patterns may comprise sequentially cutting the green substrates along line B1-B2 crossing the internal and external substrate electrode patterns 16 and 18, and along lines A1-A2, A3-A4, A5-A6, A7-A8 and A9-A10 passing between the internal and external substrate electrode patterns 16 and 18.

Referring to FIGS. 6 and 7, when two green bodies 2 and 4 are prepared, a piezoelectric resonator 80 having connection electrodes 74 and 78, between the internal resonant electrode patterns 54 and 58 and between the external resonant electrode patterns 34 and 38 to be disposed on the piezoelectric resonant pattern 70, is formed according to the first and second embodiments of the present invention. Each of the connection electrodes 74 and 78 may be formed of at least one conductive layer. Here, the connection electrodes 74 and 78 may be in contact with the external resonant electrode patterns 34 and 38, the resonant patterns 44 and 48, and the internal resonant electrode patterns 54 and 58, the connecting adhesive pattern 64 and the insulating adhesive pattern 68. Here, the connection electrodes 74 and 78, between which the resonant patterns 44 and 48 are disposed, are electrically isolated from each other. The connection electrodes 74 and 78 may be formed to have the same or different thicknesses due to the structure of the piezoelectric resonant pattern 70.

Meanwhile, when two or more even number of green bodies are prepared, a piezoelectric resonator 80 having connection electrodes 74 and 78, between the internal resonant electrode patterns 54 and 58 and between the external resonant electrode patterns 34 and 38 to be disposed on the piezoelectric resonant pattern 70, is provided according to the second embodiment of the present invention equivalent to the first embodiment of the present invention. Also, pairs of substrates are repeatedly selected from the rest of the green substrates, forming the internal and external substrate electrode patterns 16 and 18 thereon, forming the adhesive agent 29, forming the piezoelectric resonant pattern 70, and forming the piezoelectric resonator 80, sequentially. Also, the third embodiment of the present invention, unlike the first and second embodiments of the present invention, may provide several piezoelectric resonators 80 having connection electrodes 74 and 78, which are disposed on one piezoelectric resonant pattern 70 repeatedly selected from the piezoelectric resonant patterns to connect the external resonant electrode patterns 34 and 38 to each other, and the internal resonant electrode patterns 54 and 58 to each other. According to the second and third embodiments of the present invention, the connection electrodes 74 and 78 may be formed to have the same or different thicknesses due to the structure of the piezoelectric resonant pattern 70.

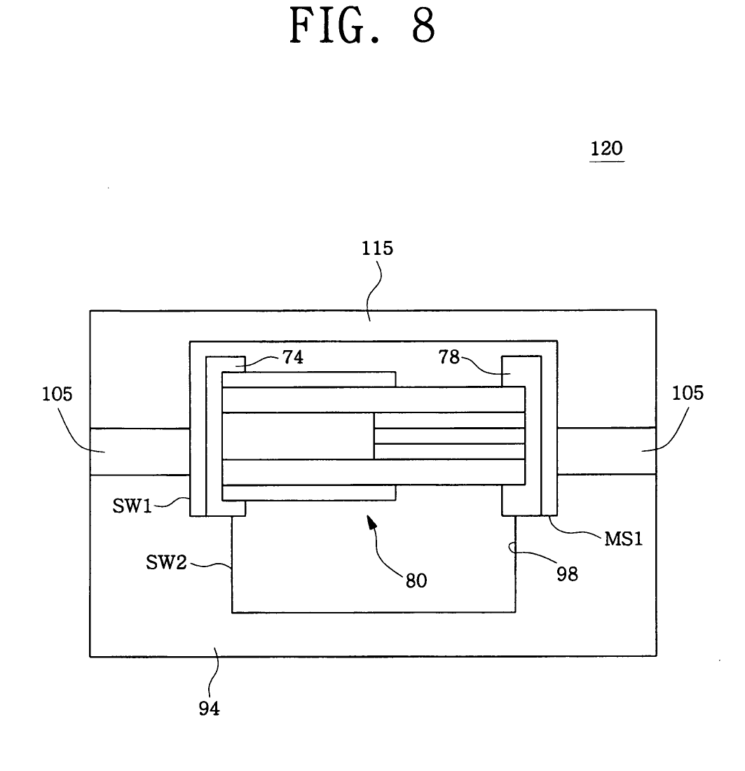

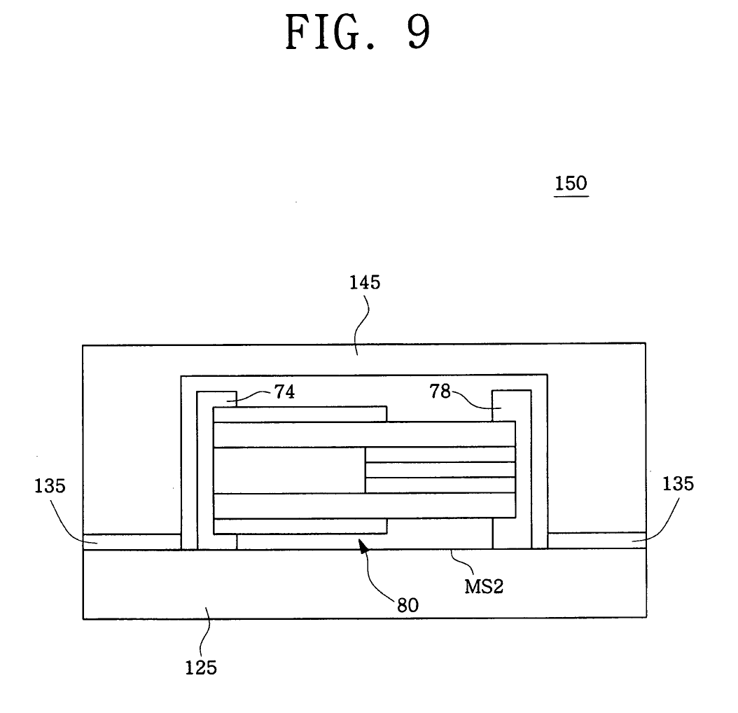

FIG. 8 is a cross-sectional view of a multilayered piezoelectric resonant device having the piezoelectric resonator of FIG. 7, and FIG. 9 is a cross-sectional view of a cap-shaped piezoelectric resonant device having the piezoelectric resonator of FIG. 7.

Referring to FIGS. 7 and 8, a protection cap 115, a resonant base 94 and a piezoelectric resonator 80 are prepared. The piezoelectric resonator 80 may be formed according to one selected from the first to fourth embodiments of the present invention. The resonant base 94 may be formed of a ceramic material. The resonant base 94 has a resonant groove 98, the resonant groove 98 having sidewalls SW1 and SW2 spaced apart form each other. A mounting surface 1 MS1 is disposed between the sidewalls SW1 and SW2 of the resonant groove 94. Subsequently, a protection adhesive layer 105 is formed on the resonant base 94. The protection adhesive layer 105 may be formed on the resonant base 94 to surround the resonant groove 98, and the protection adhesive layer 105 may be formed of an insulating material.

The piezoelectric resonator 80 is mounted on the resonant base 94. Here, the piezoelectric resonator 80 may be disposed on the mounting surface 1 MS1 of the resonant groove 98. As a result, the piezoelectric resonator 80 may be electrically connected to the resonant base 94 using the connection electrodes 74 and 78. Also, the protection cap 115 is formed on the resonant base 94. The protection cap 115 may be formed of a ceramic material. Here, the protection cap 115 may be attached to the resonant base 94 with the protection adhesive layer 105. Therefore, the protection cap 115, the piezoelectric resonator 80, and the resonant base 94 may constitute a multilayered piezoelectric resonant device 120.

Referring to FIGS. 7 and 9, a protection cap 145, a plate base 125 and a piezoelectric resonator 80 are prepared. The piezoelectric resonator 80 may be formed according to one selected from the first to fourth embodiments of the present invention. The plate base 125 may be formed of a ceramic material. The plate base 125 has a mounting surface 2 MS2. Subsequently, the piezoelectric resonator 80 is mounted on the plate base 125. Here, the piezoelectric resonator 80 may be disposed on the mounting surface 2 MS2 of the plate base 125. Therefore, the piezoelectric resonator 80 may be electrically connected to the plate base 125 using connection electrodes 74 and 78.

A protection adhesive layer 135 is formed on the plate base 125. The protection adhesive layer 135 may be formed on the plate base 125 to surround the piezoelectric resonator 80. The protection adhesive layer 135 may be formed of an insulating material. Here, the protection cap 145 may be attached on the plate base 125 with the protection adhesive layer 135. Therefore, the protection cap 145, the piezoelectric resonator 80 and the plate base 125 may constitute a cap-shaped piezoelectric resonant device 150.

As described above, the invention provides methods of forming a piezoelectric resonant device having a piezoelectric resonator. Accordingly, green bodies are sintered and grinded in advance, thereby minimizing an effect of the production process on the green bodies, which may improve an electrical characteristic of the piezoelectric resonator.

Exemplary embodiments of the present invention have been disclosed herein and, although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A method of forming a piezoelectric resonant device, comprising:
preparing two green bodies, each of the green bodies being formed into a cube surrounded by six planes;
sintering the green bodies;
forming green substrates by grinding the green bodies, respectively;
forming substrate polarizing layers on facing surfaces between the green substrates and opposite surfaces to the facing surfaces;
polarizing the green substrates using the substrate polarizing layers;
forming internal and external substrate electrode patterns on the green substrates using the substrate polarizing layers, the internal and external substrate electrode patterns being formed on the facing surfaces between the green substrates, and the opposite surfaces to the facing surfaces, respectively;
forming an adhesive agent on the facing surfaces between the green substrates;
forming at least one piezoelectric resonant pattern by cutting the green substrates, the piezoelectric resonant pattern having a connecting adhesive pattern, an insulating adhesive pattern, resonant patterns, and external and internal resonant electrode patterns, the external and internal resonant electrode patterns and the resonant patterns respectively corresponding to the internal and external substrate electrode patterns and the green substrates, and the connecting and insulating adhesive patterns corresponding to the adhesive agent; and
forming a piezoelectric resonator having connection electrodes between the internal resonant electrode patterns and between the external resonant electrode patterns to be disposed on the piezoelectric resonant pattern.

2. The method according to claim 1, wherein each of the connection electrodes is formed of at least one conductive layer.

3. The method according to claim 1, wherein forming the piezoelectric resonant pattern comprises:
cutting the green substrates in the order of passing between and crossing the internal and external substrate electrode patterns,
the internal resonant electrode patterns being disposed on one side of the facing surfaces between the resonant patterns to face each other, the external resonant electrode patterns being formed on the opposite surfaces to the facing surfaces between the resonant patterns to overlap the other side of the facing surfaces between the resonant patterns, the insulating adhesive pattern being disposing between the resonant patterns to be in contact with the connecting adhesive pattern, and the connecting adhesive pattern being formed to be disposed between the internal resonant electrode patterns.

4. The method according to claim 1, wherein forming the piezoelectric resonant pattern comprises:
cutting the green substrates in the order of crossing and passing between the internal and external substrate electrode patterns,
the internal resonant electrode patterns being disposed on one side of the facing surfaces between the resonant patterns to face each other, the external resonant electrode patterns being formed on the opposite surfaces to the facing surfaces between the resonant patterns to overlap the other side of the facing surfaces between the resonant patterns, the insulating adhesive pattern being disposed between the resonant patterns to be in contact with the connecting adhesive pattern, and the connecting adhesive pattern being formed to be disposed between the internal resonant electrode patterns.

5. The method according to claim 1, wherein cutting the green substrates is performed by using a dicing saw technique.

6. The method according to claim 1, wherein the adhesive agent is formed of an insulating adhesive layer and a connecting adhesive layer, the connecting adhesive layer being in contact with the internal substrate electrode patterns and the insulating adhesive layer being disposed between the internal substrate patterns to be in contact with the green substrates.

7. The method according to claim 1, wherein forming the internal and external substrate electrode patterns comprises:
forming photoresist patterns on the substrate polarizing layers, the photoresist patterns respectively corresponding to the internal substrate electrode patterns;
removing the substrate polarizing layers using the photoresist patterns and the green substrates as an etch mask and an etch buffer layer, respectively;
removing the photoresist patterns from the green substrates;
forming other photoresist patterns on the substrate polarizing layers, the other photoresist patterns being formed to correspond to the external substrate electrode patterns, respectively;
removing the substrate polarizing layers using the other photoresist patterns and the green substrates as an etch mask and an etch buffer layer; and
removing the other photoresist patterns from the green substrates.

8. The method according to claim 1, wherein the external substrate electrode patterns are disposed between the internal substrate electrode patterns to overlap the internal substrate electrode patterns.

9. The method according to claim 1, wherein the external substrate electrode patterns are formed to be disposed between the internal substrate electrode patterns.

10. The method according to claim 1, wherein polarizing the green substrates comprises:
directly contacting electrical wires to the substrate polarizing layers in order to align polarized axes of crystals parallel to each other in the green substrates, each of the substrate polarizing layers being formed of at least one conductive layer.

11. The method according to claim 1, wherein polarizing the green substrates comprises:
forming an electric field around the substrate polarizing layers to align polarized axes of the crystals parallel to each other in the green substrates, each of the substrate polarizing layers being formed of at least one conductive layer.

12. The method according to claim 1, wherein forming the green substrates comprises:
two-dimensionally arranging the green bodies in a grinding apparatus; and
simultaneously grinding the green bodies.

13. The method according to claim 1, wherein forming the green substrates comprises:
inserting one of the green bodies into the grinding apparatus;
grinding the one;
inserting the rest of the green bodies into the grinding apparatus; and
continuously grinding the rest of the green bodies.

14. The method according to claim 1, wherein the green substrates are formed to have the same thickness through the grinding process.

15. The method according to claim 1, wherein the green bodies are formed of a piezoelectric material.

16. A method of forming a piezoelectric resonant device, comprising:
preparing two or more even number of green bodies, each green body being formed into a cube surrounded by six planes;
sintering the green bodies;
forming green substrates by grinding the green bodies;
forming substrate polarizing layers on facing surfaces between the green substrates and opposite surfaces to the facing surfaces;
polarizing the green substrates using the substrate polarizing layers;
selecting two green substrates from the green substrates, and forming internal and external substrate electrode patterns on the two green substrates, the internal and external substrate electrode patterns being formed on the facing surfaces between the two green substrates and the opposite surfaces to the facing surfaces using the substrate polarizing layer, respectively;
forming an adhesive agent on the facing surfaces between the two green substrates;
forming at least one piezoelectric resonant pattern by cutting the two green substrates, the piezoelectric resonant pattern having a connecting adhesive pattern, an insulating adhesive pattern, resonant patterns, external resonant electrode patterns, and internal resonant electrode patterns, the external and internal resonant electrode patterns and the resonant patterns respectively corresponding to the internal and external substrate electrode patterns and the green substrates, and the connecting and insulating adhesive patterns corresponding to the adhesive agent;
forming a piezoelectric resonator having connection electrodes between the internal resonant electrode patterns and between the external resonant electrode patterns to be disposed on the piezoelectric resonant pattern; and
repeatedly selecting two in a unit from the rest of the green substrates, and sequentially forming the internal and external substrate electrode patterns, forming the adhesive agent, forming the piezoelectric resonant pattern, and forming the piezoelectric resonator.

17. The method according to claim 16, wherein the connection electrodes, and the internal and external substrate electrode patterns are formed of at least one conductive layer.

18. The method according to claim 16, wherein forming the piezoelectric resonant pattern comprises:
cutting the green substrates in the order of passing between and crossing the internal and external substrate electrode patterns,
the internal resonant electrode patterns being disposed on one side of the facing surfaces between the resonant patterns to face each other, the external resonant electrode patterns being formed on the opposite surfaces to the facing surfaces between the resonant patterns to overlap the other side of the facing surfaces between the resonant patterns, the insulating adhesive pattern being disposed between the resonant patterns to be in contact with the connecting adhesive pattern, and the connecting adhesive pattern being formed to be disposed between the internal resonant electrode patterns.

19. The method according to claim 16, wherein forming the piezoelectric resonant pattern comprises:
cutting the green substrates in the order of crossing and passing between the internal and external substrate electrode patterns,
the internal resonant electrode patterns being disposed on one side of the facing surfaces between the resonant patterns to face each other, the external resonant electrode patterns being formed on the opposite surfaces to the facing surfaces between the resonant patterns to overlap the other side of the facing surfaces between the resonant patterns, the insulating adhesive pattern being disposed between the resonant patterns to be in contact with the connecting adhesive pattern, and the connecting adhesive pattern being formed to be disposed between the internal resonant electrode patterns.

20. The method according to claim 16, wherein cutting the green substrates is performed by using a dicing saw technique.

21. The method according to claim 16, wherein the adhesive agent is formed of an insulating adhesive layer and a connecting adhesive layer, the connecting adhesive layer being in contact with the internal substrate electrode patterns and the insulating adhesive layer being disposed between the internal substrate electrode patterns to be in contact with the green substrates.

22. The method according to claim 16, wherein forming the internal and external substrate electrode patterns comprises:
forming photoresist patterns on the substrate polarizing layers, the photoresist patterns being formed to correspond to the internal substrate electrode patterns, respectively;
removing the substrate polarizing layers using the photoresist patterns and the two green substrates as an etch mask and an etch buffer layer, respectively;
removing the photoresist patterns from the two green substrates;
forming other photoresist patterns on the substrate polarizing layers, the other photoresist patterns being formed to correspond to the external substrate electrode patterns, respectively;
removing the substrate polarizing layers using the other photoresist patterns and the two green substrates as an etch mask and an etch buffer layer, respectively; and
removing the other photoresist patterns from the two green substrates.

23. The method according to claim 16, wherein the external substrate electrode patterns are disposed between the internal substrate electrode patterns to overlap the internal substrate electrode patterns.

24. The method according to claim 16, wherein the external substrate electrode patterns are formed to be disposed between the internal substrate electrode patterns.

25. The method according to claim 16, wherein polarizing the green substrates comprises:
directly connecting electrical wires to the substrate polarizing layers to align polarized axes of crystals parallel to each other in the green substrates, each of the substrate polarizing layers being formed of at least one conductive layer.

26. The method according to claim 16, wherein polarizing the green substrates comprises:
forming an electric field around the substrate polarizing layers to align polarized axes of the crystals parallel to each other in the green substrates, each of the substrate polarizing layers being formed of at least one conductive layer.

27. The method according to claim 16, wherein forming the green substrates comprises:
two-dimensionally arranging the green bodies in a grinding apparatus; and
simultaneously grinding the green bodies.

28. The method according to claim 16, wherein forming the green substrates comprises:
inserting one of the green bodies into a grinding apparatus;
grinding the one; and
repeatedly selecting one in a unit from the rest of the green bodies, inserting into the grinding apparatus, and grinding the selected one.

29. The method according to claim 16, wherein the green substrates are formed to have the same thickness through the grinding process.

30. The method according to claim 16, wherein the green bodies are formed of a piezoelectric material.

31. A method of forming a piezoelectric resonant device, comprising:
preparing two or more even number of green bodies, each green body being formed into a cube surrounded by six planes;
sintering the green bodies;
forming green substrates by grinding the green bodies, respectively;
forming substrate polarizing layers on facing surfaces between the green substrates and opposite surfaces to the facing surfaces;
polarizing the green substrates using the substrate polarizing layers;
selecting two green substrates from the green substrates, and forming internal and external substrate electrode patterns thereon, the internal and external substrate electrode patterns being formed on the facing surfaces between the two green substrates and the opposite surfaces to the facing surfaces using the substrate polarizing layers;
forming an adhesive agent on the facing surfaces between the two green substrates;
repeatedly selecting two in a unit from the rest of the green substrates, sequentially forming the internal and external substrate electrode patterns thereon, and forming the adhesive agent;
forming piezoelectric resonant patterns by cutting the green substrates, each of the piezoelectric resonant patterns having a connecting adhesive pattern, an insulating adhesive pattern, resonant patterns, external resonant electrode patterns, and internal resonant electrode patterns, the external and internal resonant electrode patterns and the resonant patterns corresponding to the internal and external substrate electrode patterns and the green substrates, respectively, and the connecting and insulating adhesive patterns corresponding to the adhesive agent; and
repeatedly selecting one in a unit from the piezoelectric resonant patterns, and forming a plurality of piezoelectric resonators having connection electrodes between the internal resonant electrode patterns and between the external resonant electrode patterns to be disposed on the piezoelectric resonant pattern.

32. The method according to claim 31, wherein the connection electrodes, and the internal and external substrate electrode patterns are formed of at least one conductive layer.

33. The method according to claim 31, wherein forming the piezoelectric resonant patterns comprises:
cutting the green substrates in the order of passing between and crossing the internal and external substrate electrode patterns,
the internal resonant electrode patterns being disposed on one side of the facing surfaces between the resonant patterns to face each other, the external resonant electrode patterns being formed on the opposite surfaces to the facing surfaces between the resonant patterns to overlap the other side of the facing surfaces between the resonant patterns, the insulating adhesive pattern being disposed between the resonant patterns to be in contact with the connecting adhesive pattern, and the connecting adhesive pattern being formed to be disposed between the internal resonant electrode patterns.

34. The method according to claim 31, wherein forming the piezoelectric resonant patterns comprises:
cutting the green substrates in the order of crossing and passing between the internal and external substrate electrode patterns,
the internal resonant electrode patterns being disposed on one side of the facing surfaces between the resonant patterns to face each other, the external resonant electrode patterns being formed on the opposite surfaces to the facing surfaces between the resonant patterns to overlap the other side of the facing surfaces between the resonant patterns, the insulating adhesive pattern being disposed between the resonant patterns to be in contact with the connecting adhesive pattern, and the connecting adhesive pattern being formed to be disposed between the internal resonant electrode patterns.

35. The method according to claim 31, wherein cutting the green substrates is performed by using a dicing saw technique.

36. The method according to claim 31, wherein the adhesive agent is formed of an insulating adhesive layer and a connecting adhesive layer, the connecting adhesive layer being in contact with the internal substrate electrode patterns, and the insulating adhesive layer being disposed between the internal substrate electrode patterns to be in contact with the green substrates.

37. The method according to claim 31, wherein forming the internal and external substrate electrode patterns comprises:
forming photoresist patterns on the substrate polarizing layers, the photoresist patterns being formed to correspond to the internal substrate electrode patterns, respectively;
removing the substrate polarizing layers using the photoresist patterns and the two green substrates as an etch mask and an etch buffer layer, respectively;
removing the photoresist patterns from the two green substrates;
forming other photoresist patterns on the substrate polarizing layers, the other photoresist patterns being formed to correspond to the external substrate electrode patterns, respectively;
removing the substrate polarizing layers using the other photoresist patterns and the two green substrates as an etch mask and an etch buffer layer, respectively; and
removing the other photoresist patterns from the two green substrates.

38. The method according to claim 31, wherein the external substrate electrode patterns are disposed between the internal substrate electrode patterns to overlap the internal substrate electrode patterns.

39. The method according to claim 31, wherein the external substrate electrode patterns are formed to be disposed between the internal substrate electrode patterns.

40. The method according to claim 31, wherein polarizing the green substrates comprises:
directly connecting electrical wires to the substrate polarizing layers to align polarized axes of crystals parallel to each other in the green substrates, each substrate polarizing layer being formed of at least one conductive layer.

41. The method according to claim 31, wherein polarizing the green substrates comprises:
forming an electric field around the substrate polarizing layers to align polarized axes of the crystals parallel to each other in the green substrates, each substrate polarizing layer being formed of at least one conductive layer.

42. The method according to claim 31, wherein forming the green substrates comprises:
two-dimensionally arranging the green bodies in a grinding apparatus; and
simultaneously grinding the green bodies.

43. The method according to claim 31, wherein forming the green substrates comprises:
inserting one of the green bodies into the grinding apparatus;
grinding the one; and
repeatedly selecting one in a unit from the rest of the green bodies, inserting the selected one into the grinding apparatus, and grinding the selected one.

44. The method according to claim 31, wherein the green substrates are formed to have the same thickness through the grinding process.

45. The method according to claim 31, wherein the green bodies are formed of a piezoelectric material.

46. A method of forming a piezoelectric resonant device, comprising:
preparing two green bodies, each green body being formed into a cube surrounded by six planes;
sintering the green bodies;
forming green substrates by grinding the green bodies, respectively;
forming internal and external substrate electrode patterns on facing surfaces between the green substrates and on opposite surfaces to the facing surfaces, respectively;
polarizing the green substrates using the internal and external substrate electrode patterns;
forming an adhesive agent on the facing surfaces between the green substrates;
forming at least one piezoelectric resonant pattern by cutting the green substrates, the at least one piezoelectric resonant pattern having a connecting adhesive pattern, an insulating adhesive pattern, resonant patterns, external resonant electrode patterns and internal resonant electrode patterns, the external and internal resonant electrode patterns and the resonant patterns respectively corresponding to the internal and external substrate electrode patterns and the green substrates, and the connecting and insulating adhesive patterns corresponding to the adhesive agent; and
forming a piezoelectric resonator having connection electrodes between the internal resonant electrode patterns and between the external resonant electrode patterns to be disposed on the piezoelectric resonant pattern.

47. The method according to claim 46, wherein each connection electrode, and the internal and external substrate electrode patterns are formed of at least one conductive layer.

48. The method according to claim 46, wherein forming the piezoelectric resonant patterns comprises:
cutting the green substrates in the order of passing between and crossing the internal and external substrate electrode patterns,
the internal resonant electrode patterns being disposed on one side of the facing surfaces between the resonant patterns to face each other, the external resonant electrode patterns being formed on the opposite surfaces to the facing surfaces between the resonant patterns to overlap the other side of the facing surfaces between the resonant patterns, the insulating adhesive pattern being disposed between the resonant patterns to be in contact with the connecting adhesive pattern, and the connecting adhesive pattern being formed to be disposed between the internal resonant electrode patterns.

49. The method according to claim 46, wherein forming the piezoelectric resonant patterns comprises:
cutting the green substrates in the order of crossing and passing between the internal and external substrate electrode patterns,
the internal resonant electrode patterns being disposed on one side of the facing surfaces between the resonant patterns to face each other, the external resonant electrode patterns being formed on the opposite surfaces to the facing surfaces between the resonant patterns to overlap the other side of the facing surfaces between the resonant patterns, the insulating adhesive pattern being disposed between the resonant patterns to be in contact with the connecting adhesive pattern, and the connecting adhesive pattern being formed to be disposed between the internal resonant electrode patterns.

50. The method according to claim 46, wherein cutting the green substrates is performed by using a dicing saw technique.

51. The method according to claim 46, wherein the adhesive agent is formed of an insulating adhesive layer and a connecting adhesive layer, the connecting adhesive layer being in contact with the internal substrate electrode patterns, and the insulating adhesive layer being disposed between the internal substrate electrode patterns to be in contact with the green substrates.

52. The method according to claim 46, wherein forming the internal and external substrate electrode patterns comprises:
forming conductive paste patterns on the green substrates, the conductive paste patterns being formed to correspond to the internal substrate electrode patterns, respectively;
forming other conductive paste patterns on the green substrates, the other conductive paste patterns being formed to correspond to the external substrate electrode patterns, respectively; and
thermally treating the green substrates, the conductive paste patterns, and the other conductive paste patterns.

53. The method according to claim 46, wherein the external substrate electrode patterns are disposed between the internal substrate electrode patterns to overlap the internal substrate electrode patterns.

54. The method according to claim 46, wherein the external substrate electrode patterns are formed to be disposed between the internal substrate electrode patterns.

55. The method according to claim 46, wherein polarizing the green substrates comprises:
directly connecting electrical wires to the internal and external substrate electrode patterns to align polarized axes of crystals parallel to each other in the green substrates, each of the internal and external substrate electrode patterns being formed of at least one conductive layer.

56. The method according to claim 46, wherein polarizing the green substrates comprises:
forming an electric field around the internal and external substrate electrode patterns to align polarized axes of the crystals parallel to each other in the green substrates, each of the internal and external substrate electrode patterns being formed of at least one conductive layer.

57. The method according to claim 46, wherein forming the green substrates comprises:
two-dimensionally arranging the green bodies in a grinding apparatus; and
simultaneously grinding the green bodies.

58. The method according to claim 46, wherein forming the green substrates comprises:
inserting one of the green bodies into the grinding apparatus;
grinding the one;
inserting the rest of the green bodies in the grinding apparatus; and
continuously grinding the rest of the green bodies.

59. The method according to claim 46, wherein the green substrates are formed to have the same thickness through the grinding process.

60. The method according to claim 46, wherein the green bodies are formed of a piezoelectric material.
